(19) United States
(12) Patent Application Publication
(10) Pub. No.: US 2026/0121081 A1
(43) Pub. Date: Apr. 30, 2026

(54) LIQUID METAL OXIDE COMPOSITES AS A SOURCE OF ELECTROCHEMICAL ENERGY AND USES THEREOF

(71) Applicant: Trustees of Boston University, Boston, MA (US)

(72) Inventors: John William Boley, Cambridge, MA (US); Xing Ye, Boston, MA (US)

(73) Assignee: Trustees of Boston University, Boston, MA (US)

(21) Appl. No.: 19/365,463

(22) Filed: Oct. 22, 2025

Related U.S. Application Data
(60) Provisional application No. 63/711,347, filed on Oct. 24, 2024.

(51) Int. Cl. H01M 6/38; H01M 4/12; H01M 4/36; H01M 4/38; H01M 6/42; H01M 50/121

(52) U.S. Cl. CPC H01M 6/38; H01M 4/12; H01M 4/368; H01M 4/38; H01M 6/42; H01M 50/121; H01M 2220/30

(57) ABSTRACT

An approach to generating electrical energy includes providing a composite material having liquid metal droplets dispersed in at least one of an ionically-conductive liquid or an ionically conductive polymer. The composite material is enclosed within a flexible, stretchable enclosure. At least two electrodes are embedded within the composite material. The enclosure is mechanically deformed to cause relative movement between at least one of the electrodes and the composite material, thereby rupturing oxide layers present on surfaces of the liquid metal droplets and inducing an electrochemical reaction that generates electrical energy.

### CROSS-REFERENCE TO RELATED APPLICATIONS

This application claims benefit under 35 U.S.C. § 119 of U.S. Provisional Application No. 63/711,347 filed Oct. 24, 2024, the contents of which are incorporated herein by reference in their entirety.

### TECHNICAL FIELD

This disclosure relates to electrochemical energy and, more particularly, to liquid metal oxide composites as sources of electrochemical energy.

### BACKGROUND

Liquid metals, such as alloys of gallium, exhibit melting points at room temperature. Unlike mercury, which evaporates and produces toxic vapor, gallium-based liquid metals have practically zero vapor pressure and are safe to handle in various applications. They have unique mechanical and electrical properties because they simultaneously behave like a metal and a liquid. These properties make liquid metals an ideal candidate for soft electronics and stretchable conductors. Liquid metals can find their applications in soft electronic circuits, stretchable electrical interconnects, flexible sensors, reconfigurable antennas, drug delivery, and hermetic seals.

Liquid metal is also an excellent electrode material for stretchable batteries because it has good deformability and high efficiency owing to its liquid form. A few emerging battery designs featuring gallium-based liquid metals demonstrated promising performance. Most of the current designs of liquid metal batteries operate by stripping and depositing metal anodes in alkaline electrolytes. Few gallium-based liquid metal batteries can work in more eco-friendly electrolytes, such as ionic liquid or pH-neutral aqueous solutions. Despite having many interesting properties, a drawback of gallium-based liquid metals is that they rapidly form a thin layer of oxide on their surface in the presence of oxygen. This oxide layer has typically been considered a nuisance because it sticks to many surfaces and interferes with electrochemical measurements.

### SUMMARY

According to one aspect of the current disclosure, a method of generating electrical energy is provided. The method includes providing a composite material comprising a plurality of liquid metal droplets dispersed in at least one of an ionically-conductive liquid or an ionically conductive polymer; enclosing the composite material within a flexible, stretchable enclosure; embedding at least two electrodes within the composite material; and mechanically deforming the enclosure to cause relative movement between at least one of the electrodes and the composite material, thereby rupturing oxide layers present on surfaces of the liquid metal droplets and inducing an electrochemical reaction that generates electrical energy.

In some exemplary embodiments, the liquid metal droplets comprise a gallium-based alloy.

In some exemplary embodiments, the ionically-conductive liquid comprises an ionic liquid selected from 1-ethyl-3-methyl-imidazolium dicyanamide, 1-ethyl-3-methyl-imidazolium acetate, or 1-ethyl-3-methyl-imidazolium ethyl sulfate.

In some exemplary embodiments, the fumed silica particles are present in an amount of 0.1 wt % to 10 wt % based on a total weight of the composite material.

In some exemplary embodiments, the flexible, stretchable enclosure comprises a silicone elastomer and the mechanical deformation comprises applying a tensile strain of at least 5%.

In some exemplary embodiments, the method further comprises repeatedly deforming the enclosure at a frequency between 0.1 Hz and 5 Hz to generate successive electrical pulses.

In some exemplary embodiments, the composite material is configured such that energy generation is mechanically gated and substantially absent when the device is at rest.

In some exemplary embodiments, the voltage and/or power output is increased by electrically connecting multiple devices in series or parallel.

In some exemplary embodiments, the liquid metal is doped with a metal selected from aluminum, rare-earth metals, or combinations thereof, to increase the open-circuit voltage of the device.

In some exemplary embodiments, the electrodes are made from a material selected from copper, carbon, stainless steel, or combinations thereof.

According to another aspect of the current disclosure, a stretchable battery device is provided. The device includes a composite emulsion comprising a plurality of liquid metal droplets dispersed in at least one of an ionically-conductive liquid or an ionically conductive polymer. A flexible, stretchable enclosure encapsulates the composite emulsion. At least two electrodes are embedded within the composite emulsion, wherein at least one electrode is configured to move relative to the composite emulsion upon mechanical deformation of the enclosure such that the movement ruptures oxide layers on the liquid metal droplets and generates electrical energy.

In some exemplary embodiments, the enclosure comprises silicone rubber and the at least two electrodes comprise tinned copper wires, an anode wire being formed in a serpentine pattern to increase collisions with the liquid metal droplets.

In some exemplary embodiments, the composite emulsion comprises a plurality of liquid metal droplets, an ionically-conductive liquid, and fumed silica particles present in an amount sufficient to stabilize the dispersion of the liquid metal droplets within the ionically-conductive liquid.

In some exemplary embodiments, the device is robust against self-discharge and environmental degradation due to the presence of the oxide layer and the stability of the ionic liquid.

In some exemplary embodiments, the device is configured for use in wearable electronics, soft robotics, or implantable medical devices.

In some exemplary embodiments, the composite emulsion further comprises fumed silica particles.

According to another aspect of the current disclosure, a self-powered sensor device is provided. The device includes a composite emulsion comprising liquid metal droplets dispersed in at least one of an ionically-conductive liquid or an ionically-conductive polymer and a flexible enclosure containing the composite emulsion. At least one rigid electrode is embedded within the composite emulsion and configured such that mechanical input to the enclosure causes the electrode to rupture oxide layers on the liquid metal droplets, thereby generating a transient electrical signal in response to the mechanical input.

In some exemplary embodiments, the rigid electrode comprises copper or stainless steel and is oriented so that compression perpendicular to the enclosure deflects the electrode through the composite emulsion.

In some exemplary embodiments, the device further comprises a signal-processing circuit configured to detect voltage transients generated by the device and to output corresponding digital signals.

In some exemplary embodiments, the composite emulsion further comprises fumed silica particles.

According to another aspect of the current disclosure, a composite material for electrochemical energy generation is provided. The material includes liquid metal and an ionically-conductive liquid or ionically conductive polymer in which the liquid metal or polymer droplets are dispersed. Fumed silica particles are present in an amount sufficient to stabilize the dispersion of the liquid metal droplets within the ionically-conductive liquid, wherein the composite material is configured to generate electrical energy upon mechanical rupture of oxide layers on the liquid metal droplets.

According to another aspect of the current disclosure, a method of fabricating a stretchable battery is provided. The method includes preparing a composite emulsion by mixing liquid metal, an ionically-conductive liquid, and fumed silica particles to form a stabilized dispersion of liquid metal droplets; enclosing the composite emulsion within a flexible, stretchable polymeric enclosure; and embedding at least two electrodes within the composite emulsion, wherein the electrodes are positioned such that mechanical deformation of the enclosure causes at least one electrode to rupture oxide layers on the liquid metal droplets, thereby enabling electrochemical energy generation.

### BRIEF DESCRIPTION OF THE DRAWINGS

FIGS. 1A through 1H include schematic diagrams illustrating the rupturing of the liquid metal oxide, which converts chemical energy to electrical energy, according to some exemplary embodiments.

FIGS. 2A through 2G include schematic diagrams illustrating a liquid metal-ionic liquid emulsion, according to some exemplary embodiments.

FIGS. 3A through 3I include schematic diagrams illustrating a soft stretchable device, according to some exemplary embodiments.

FIGS. 4A through 4F include schematic diagrams illustrating applications of the liquid metal emulsion-based device, according to some exemplary embodiments.

FIGS. 5A-5B include graphs illustrating open-circuit voltage and short-circuit current, respectively, of the scratching liquid metal surface process during one scratching cycle, according to some exemplary embodiments.

FIGS. 6A-6C illustrate comparison of short-circuit currents in systems with different liquid electrolytes in the scratching liquid metal surface process, according to some exemplary embodiments.

FIG. 7 includes a schematic diagram illustrating generating the liquid metal-ionic liquid emulsion by mixing liquid metal, ionic liquid, and fumed silica in a SpeedMixer, according to some exemplary embodiments.

FIGS. 8A through 8C illustrate distributions of the liquid metal droplets, according to some exemplary embodiments.

FIG. 9 includes a schematic diagram illustrating fabrication of stretchable devices of FIGS. 3A through 3I, according to some exemplary embodiments.

FIG. 10 includes a graph illustrating time constants of the voltage decay curves of the stretchable battery in FIG. 3 under different loads.

FIG. 11 includes a graph illustrating a peak voltage profile of a stretchable battery of FIGS. 3A through 3I during 20,000 stretching cycles.

FIG. 12 includes a graph illustrative voltage change of the six buttons of the self-powered keypad of FIGS. 4D and 4E when they are pressed.

FIGS. 13A through 13B illustrate Gibbs free energy and standard reduction potential of formations of select non-hazardous metal oxides.

### DETAILED DESCRIPTION

Despite having many interesting properties, a drawback of gallium-based liquid metals is that they rapidly form a thin layer of oxide on their surface in the presence of oxygen. This oxide layer has typically been considered a nuisance because it sticks to many surfaces and interferes with electrochemical measurements. Some applications taken advantage of the oxide layer on the surface of gallium-based liquid metals by exploiting the presence of the oxide skin, including manipulating the shape of liquid metals, i.e., shape reconfigurable electronics, three-dimensional (3D) and four-dimensional (4D) printing and printed structures, and unconventional actuators.

Described in detail herein is a new approach to processing liquid metal oxide by using it as an electrochemical energy source. Because the formation of liquid metal oxide is a spontaneous process, the current technology harnesses its electrochemical energy and develops a galvanic cell. According to current technology; by mechanically rupturing their surface oxide, liquid metals form a primary battery; converting their chemical energy to electrical energy. The current technology introduces a composite material with dispersed liquid metal droplets in an ionically-conductive liquid to form emulsions that allows device fabrication and customization. The power output of this device is activated by input strain and therefore does not have current leakage at rest, unlike conventional stretchable batteries whose chemical reactions occur regardless of their mechanical state. Protected by the oxide skin naturally: the passivating oxide layer of the liquid metal shields it from self-discharge over time or changes ambient conditions, such as high temperature or aquatic environments, which is an advantage over traditional batteries that suffer from stability issues.

According to the current disclosure, applications provided include a strain-activated stretchable battery that produces ˜500 mV of open-circuit voltage and up to ˜4 μW of power. This technology can be used in fabricating stretchable batteries with long shelf life and self-powered devices with robust performance. Other applications include a pressure-sensitive self-powered keypad.

### Scratching Liquid Metal Surface Induces Electrochemical Energy

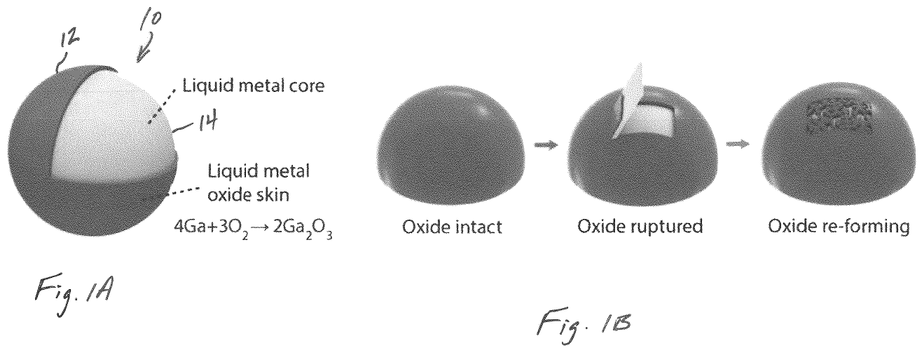

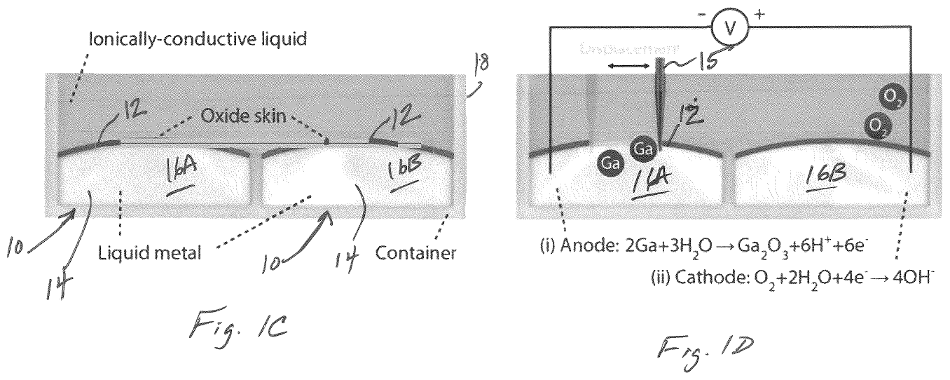

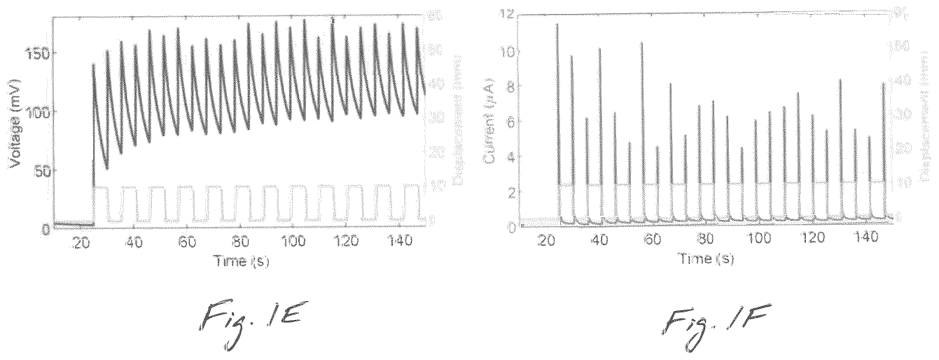

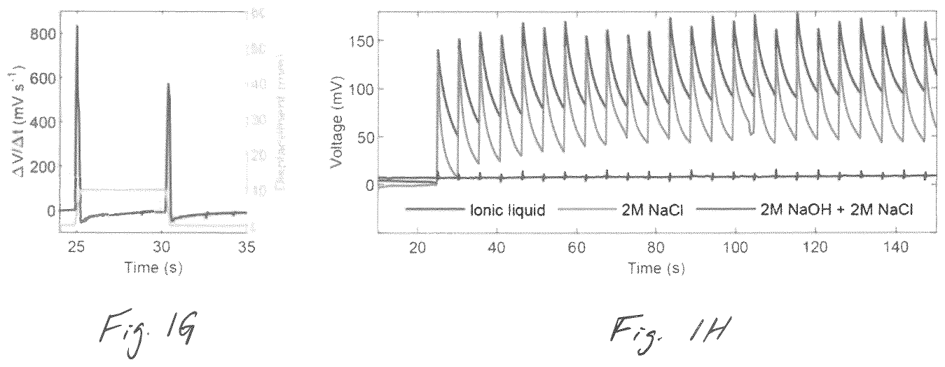

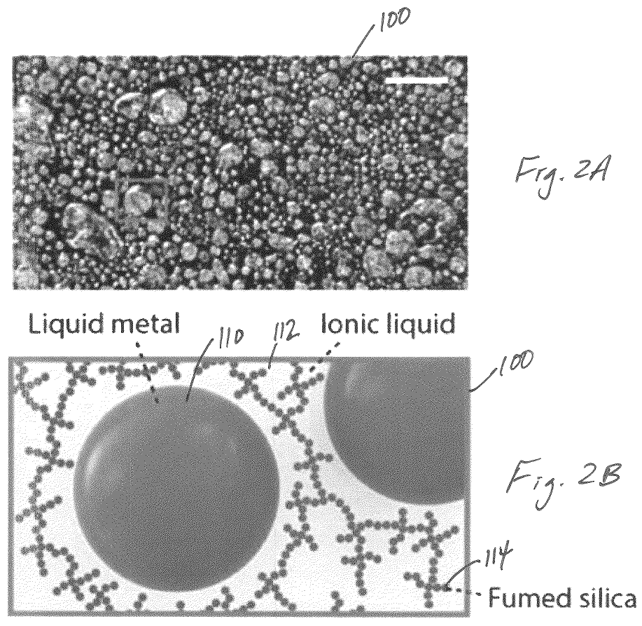

In some particular exemplary embodiments, the liquid metal is eutectic gallium-indium (EGaIn). According to the current technology, scratching or rupturing the liquid metal surface induces electrochemical energy. FIGS. 1A through 1H include schematic diagrams illustrating the rupturing of the liquid metal oxide, which converts chemical energy to electrical energy, according to some exemplary embodiments. FIG. 1A includes a schematic illustration of a liquid metal element of the current technology, according to some exemplary embodiments. Referring to FIG. 1A, the liquid metal element or droplet 10 spontaneously develops a thin and protective liquid metal oxide skin or oxide layer 12 on the surface of its liquid metal core 14 surface in the presence of oxygen. The surface of liquid metal is covered by the layer of oxide skin 12 because gallium reacts with oxygen in the environment. This oxide skin 12 is predominantly composed of gallium oxide because gallium oxidation happens more readily than indium oxidation. Although the oxide skin 12 protects the liquid metal core 14 from further oxidation, this oxide skin or shell 12 itself is brittle and susceptible to mechanical fracture. If the oxide skin 12 is ruptured in an oxygen-containing environment by mechanical forces, such as stirring or vibration, the oxide skin 12 will rapidly re-form over the liquid metal 14 exposed by the fracture, as illustrated in FIG. 1 B, which includes schematic diagrams illustrating the liquid metal element 10 intact prior to mechanical rupturing, then the liquid metal element 10 ruptured, then the liquid metal element 10 with oxide skin 12 reforming. The liquid metal oxide skin is brittle and can be fractured by mechanical forces, but it quickly re-forms to protect the exposed liquid metal core. FIG. 1C includes a schematic diagram of a system setup, illustrating scratching or rupturing the liquid metal surface with a sharp object. Liquid metal droplets 10 are injected into two separate chambers 16A, 16B in a custom container 18 and are immersed in an ionically-conductive liquid electrolyte. With reference to FIG. 1D, a needle 15 is used to repeatedly scratch the surface 12 of the liquid metal in one of the chambers 16A to break or rupture its oxide skin 14, with the position or displacement of the needle being observed. The chemical energy of the oxide re-forming process is converted to electrical energy, which is characterized by open-circuit voltage V across the elements 10 in chambers 16A and 16B, which depends on the displacement illustrated. FIG. 1E includes a curve of the open-circuit voltage of the system according to Displacement, which varies with time according to the illustrated Displacement waveform. FIG. 1F includes a curve of the short-circuit current of the system according to Displacement, which varies with time according to the illustrated Displacement waveform. FIG. 1G includes a graph illustrating the derivative of voltage with respect to time during one scratching cycle. FIG. 1H is a graph illustrating comparison of open-circuit voltage in systems with different electrolytes.

As described in detail above in connection with FIGS. 1A through 1H, the current technology provides a galvanic cell to harness the electrochemical energy produced by the re-formation of liquid metal oxide skin 12. To implement the technology, two drops of bulk liquid metals were injected into container 18 with two chambers 16A, 16B, separated by a solid wall. Oxide skin 12 naturally formed on the surface of the liquid metals 14 during the injection process. Although the liquid metals in the two chambers were not in direct contact with each other, they were both immersed in an ionically-conductive liquid. The ions in this liquid are free to migrate across the liquid electrolyte and help maintain electrical neutrality. For this purpose, in some particular exemplary embodiments, an ionic liquid (1-ethyl-3-methylimidazolium dicyanamide, a salt in liquid form with melting point at −7° C. was used. Initially, there was no potential difference between the bulk liquid metal drops in the two sides, with reference to FIG. 1D, time less than ˜25 s). Then, the oxide skin 12 of the liquid metal 14 in the left chamber 16A was intentionally ruptured by puncturing and scratching its surface with needle 15, exposing the liquid metal core 14. This bare liquid metal, with the help of absorbed water in the ionic liquid, will immediately start to re-form its damaged oxide skin on the anode side (with reference to FIG. 1D, reaction (i)), while dissolved oxygen in the ionic liquid is consumed on the cathode side (with reference to FIG. 1D, reaction (ii)). This process converted chemical energy of the growth of liquid metal oxide into electrical energy, causing a sudden spike in open-circuit voltage or short-circuit current (with reference to FIG. 1E and FIG. 1F). The voltage or current gradually decreased as fresh oxide layer continued to cover the bare liquid metal. Since moving the needle in the reverse direction also ruptures the oxide skin, similar voltage and current peaks are observed as the needle travels back to the initial state.

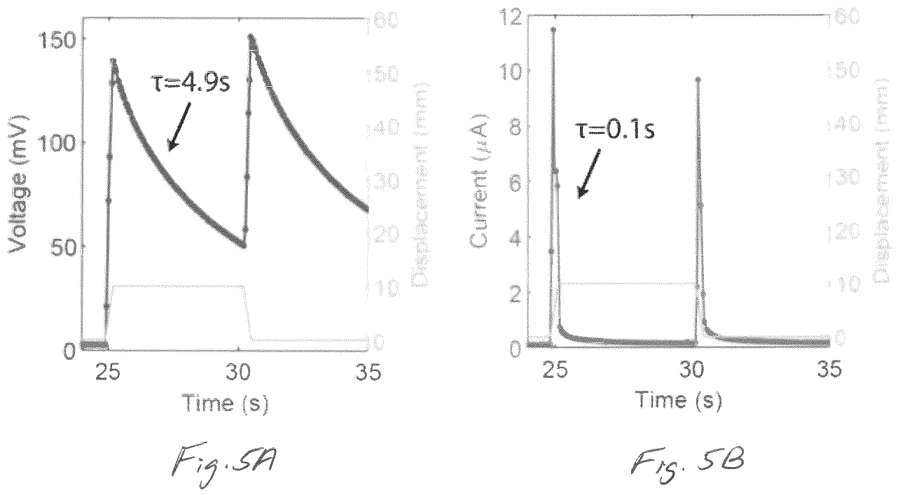

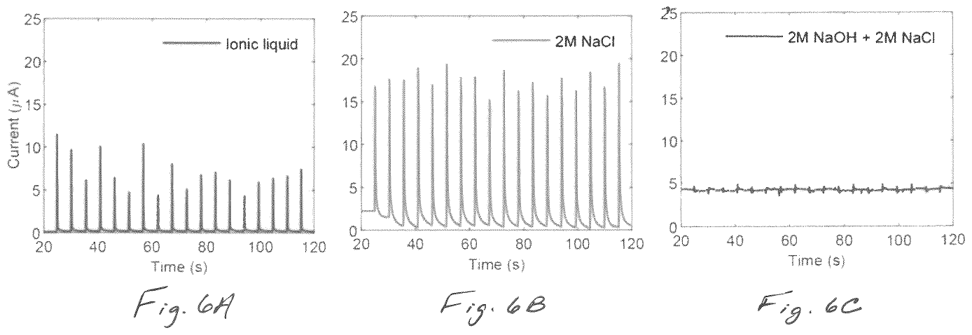

FIGS. 5A-5B include graphs illustrating open-circuit voltage and short-circuit current, respectively, of the scratching liquid metal surface process during one scratching cycle, according to some exemplary embodiments. In FIG. 5A, decay time constant is defined as elapsed time for voltage to decrease to 36.8% of its peak value. In FIG. 5B decay time constant is defined as one-fifth of elapsed time for voltage to decrease to 0.67% of its peak value.

At the beginning of a scratching cycle, the open-circuit voltage curve jumps to its peak value simultaneously with the motion of the needle 15 as the oxide skin 12 is ruptured (FIG. 1G). The voltage change is fast owing short time scale to mechanically fracture of oxide layer (typically within 10⁻³ s of needle movement). As the damaged oxide layer recovers, the charge difference between the two chambers 16A, 16B slowly reached equilibrium. The voltage curve decayed, exhibiting the typical exponential discharge process of a battery (with reference to FIG. 5A). The short-circuit current curve shares a similar pattern but has a shorter decay time constant because of its low external load (with reference to FIG. 5B).

According to some exemplary embodiments, ionic liquids can be replaced with aqueous solutions of salts as the ionically-conductive liquid electrolyte. As an example, a sodium chloride (NaCl) solution is also effective in producing energy (with reference to FIG. 1H; FIG. 6). FIGS. 6A-6C illustrate comparison of short-circuit currents in systems with different liquid electrolytes in the scratching liquid metal surface process, according to some exemplary embodiments. It has higher current than that of ionic liquid because of the increased electrical conductivity. To confirm that the presence of liquid metal oxide skin was important, a comparison experiment was performed in which sodium hydroxide (NaOH) was added to the sodium chloride solution. NaOH, as well as other basic and acidic solutions, etches away the liquid metal oxide. In this case, scratching the surface of liquid metal did not induce voltage or current changes, indicating that rupturing and re-forming oxide skin was essential.

The theoretical maximum voltage of the galvanic cell of the current technology is 0.885 V based on the standard reduction voltages of the anode and cathode reactions (−0.485 V and 0.401 V, respectively). The measured peak voltage is lower than that value, likely because of activation voltage loss (the oxide layer in the cathode side hindered interfacial charge transfer) and resistance voltage loss (relatively low electrical conductivity of ionic liquid). Because the melting point of the liquid metal alloy increases when its gallium concentration decreases, it is to be expected that the electrochemical reaction eventually stops when the liquid metal solidifies as its melting point increases above room temperature. Calculations estimate that the reaction can last up to 49 minutes for high current (1 A) applications, and up to 8 years for low current (11.5 μA) applications before the liquid metal solidifies, as referred to below.

### Liquid Metal-Ionic Liquid Emulsion

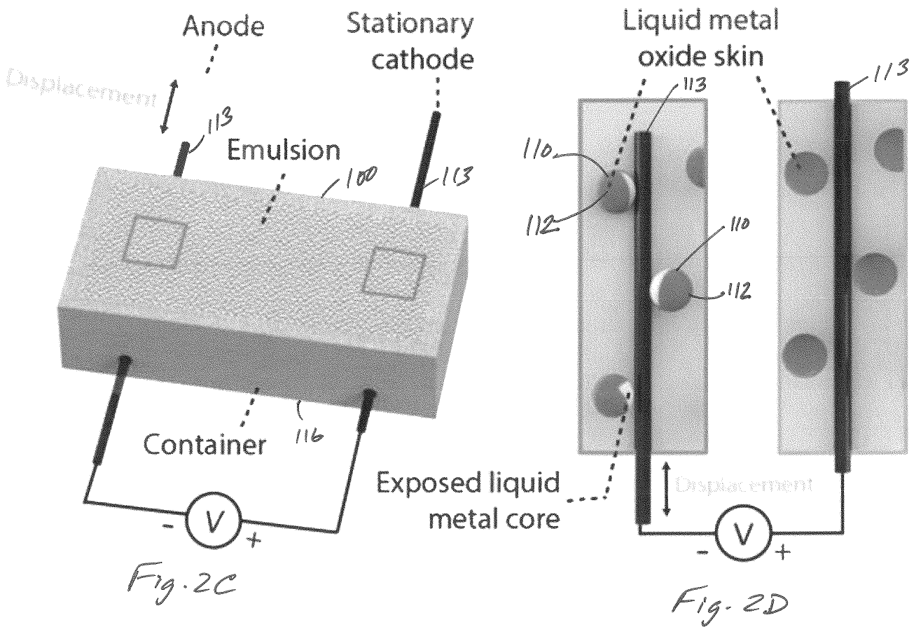

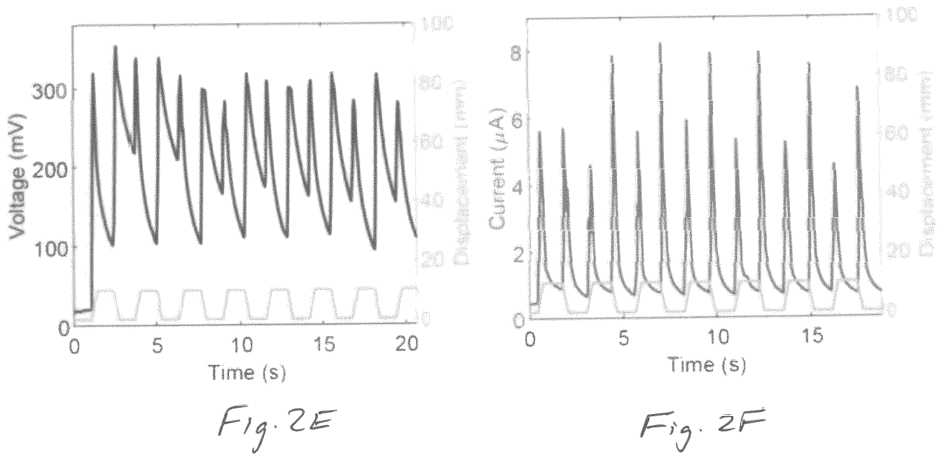

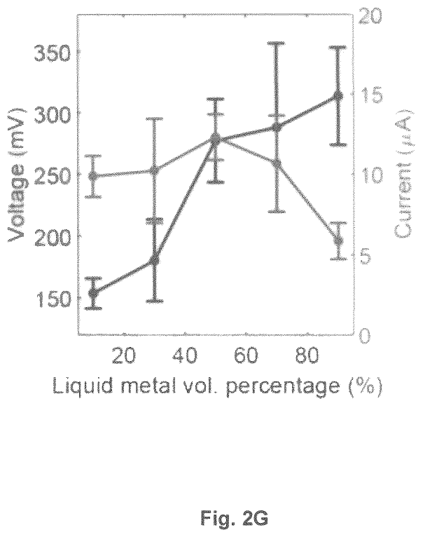

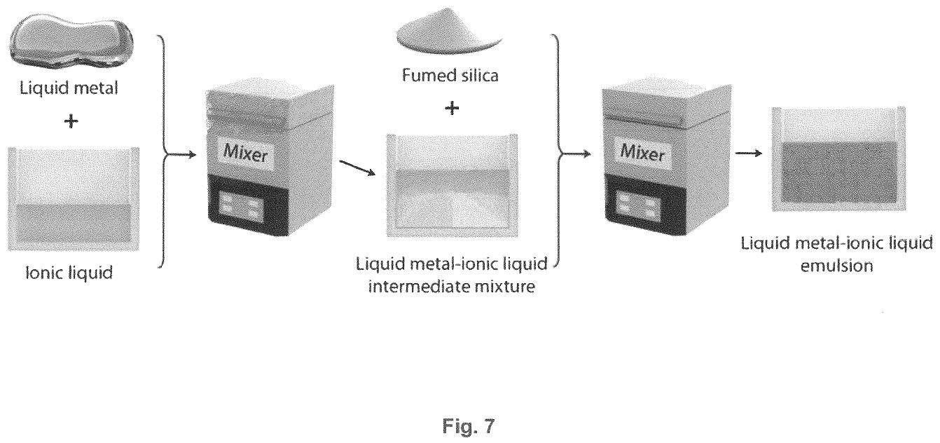

Also provided according to the current technology is a viscoelastic material based on the same working principle because it is easier to process and incorporate in functional devices. A composite material consisting of liquid metal and ionic liquid is provided, stabilized by fumed silica nanoparticles (a rheological modifier) to form an emulsion (with reference to FIG. 7). The liquid metal droplets are densely dispersed in a continuous ionic liquid phase instead of settling because the droplets are trapped in kinetically arrested assemblies with fumed silica particles (FIG. 2A and FIG. 2B). These small liquid metal droplets (12.3 μm of average diameter, FIG. 8C) created an abundance of surface to develop oxide skin. FIGS. 8A through 8C illustrate distributions of the liquid metal droplets, according to some exemplary embodiments. Specifically, FIG. 8A illustrates segmentation of an optical image of the liquid metal-ionic liquid emulsion in FIG. 2A. FIG. 8B illustrates elliptical approximation of liquid metal droplets. FIG. 8C graphically illustrates article size distribution of liquid metal droplets. Scale bars represent 100 μm. The emulsion consisted of 90 vol. % of liquid metal.

FIGS. 2A through 2G include schematic diagrams illustrating a liquid metal-ionic liquid emulsion 100, according to some exemplary embodiments. FIG. 2A includes a microscope image of the emulsion 100 with 90 vol. % of liquid metal; in which the scale bar represents 100 μm. FIG. 2B illustrates that liquid metal droplets 110 are dispersed in ionic liquid phase 112 and stabilized by fumed silica 114. FIG. 2C illustrates relative movement or displacement of a rigid wire 113 inside the emulsion induces electrochemical energy. Specifically, FIG. 2D illustrates that moving wire 113 inside the emulsion 100 collides with liquid metal droplets 110 and ruptures their oxide skins 112. FIG. 2E includes a curve of open-circuit voltage of the system based on displacement of wire 113. FIG. 2F includes a curve of short-circuit current of the system based on displacement of wire 113. FIG. 2G illustrates comparison of peak open-circuit voltage and peak short-circuit current of systems with varying concentrations of liquid metals. Error bars represent standard deviations of three samples. FIG. 7 includes a schematic diagram illustrating generating the liquid metal-ionic liquid emulsion by mixing liquid metal, ionic liquid, and fumed silica in a SpeedMixer, according to some exemplary embodiments.

The system includes a container 116 filled with this emulsion 100 and two tinned copper wires in parallel passing through it (FIG. 2C). The anode wire was pulled and pushed through holes in the container, while the cathode wire remained stationary. When the anode wire was moving inside the emulsion 110, the wire collided with liquid metal droplets 110 in its path, ruptured their oxide skins 112 temporarily, and thus induced a potential difference (FIG. 2D). The liquid metal droplets 110 quickly re-formed their oxide shells 112, allowing this energy generation process to repeat. Here, the wire 113 acted as a conductive electrode as well as a mechanical agitator. The anode wire itself did not participate in the chemical reaction because the standard reduction potentials of the oxidation of tin and copper (−0.104 V and 0.570 V, respectively) are higher than that of gallium (−0.485 V). The open-circuit voltage and short-circuit current curves showed similar patterns compared to the results in scratching the surface of bulk liquid metals (FIG. 2E and FIG. 2F). The peak voltage here was higher than that of FIG. 1E, likely because the anode wire was in contact with more individual liquid metal surfaces. The volume percentage of liquid metal in the emulsions was adjusted, and open-circuit voltages increased in emulsions with more liquid metals (FIG. 2G). The short-circuit current decreased as the emulsion consisted of more liquid metal and less ionic liquid, which lowered its overall ionic conductivity.

### Stretchable Strain-Activated Liquid Metal Battery

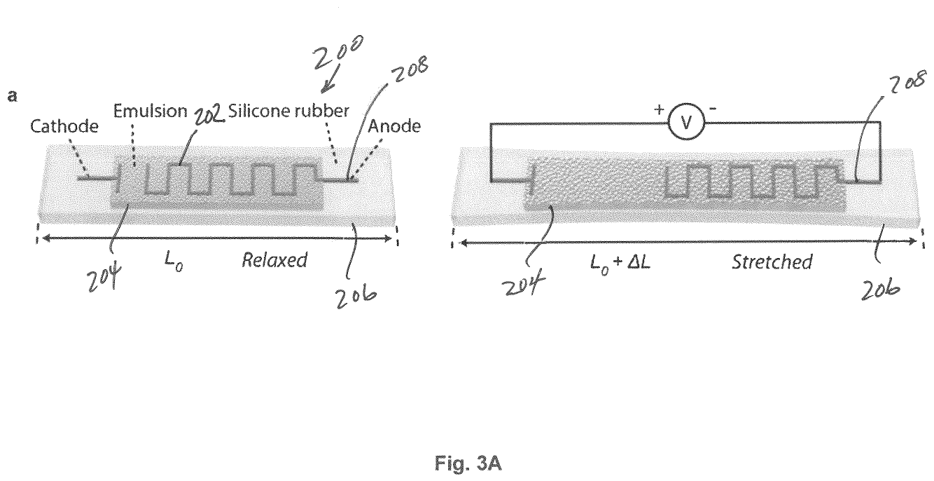

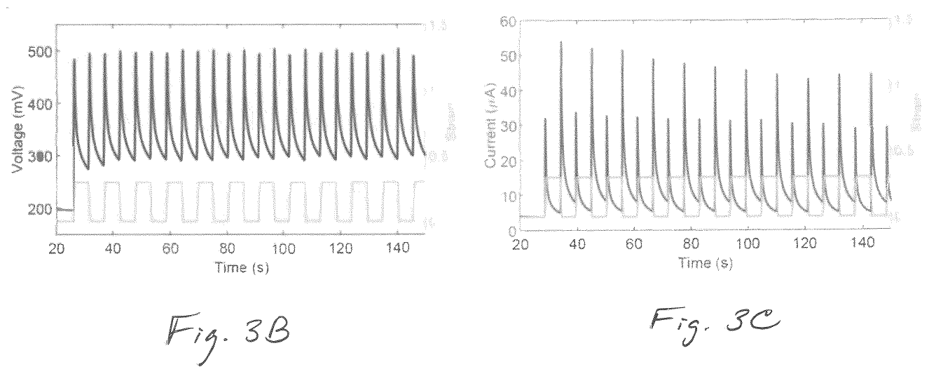

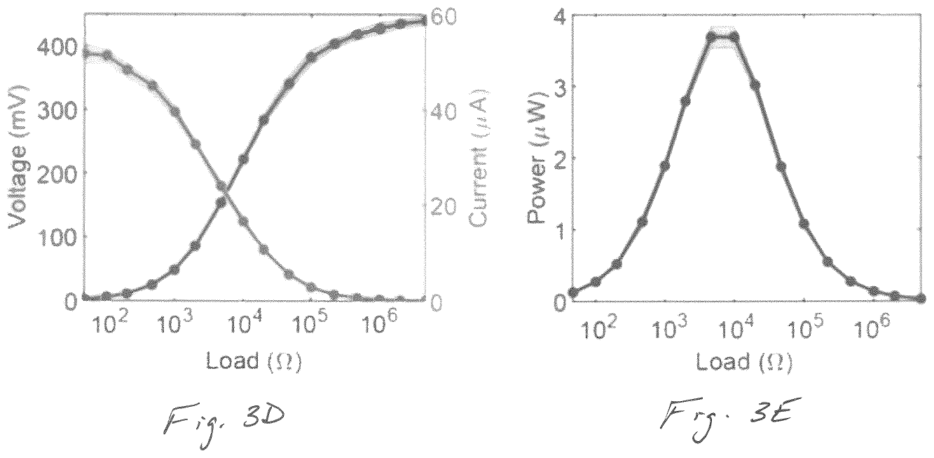

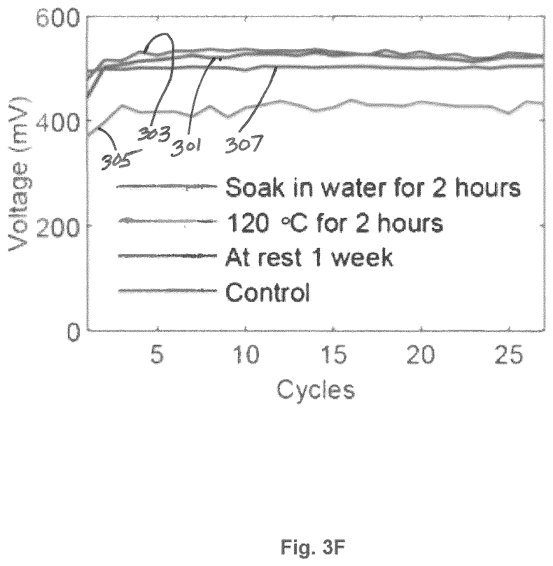

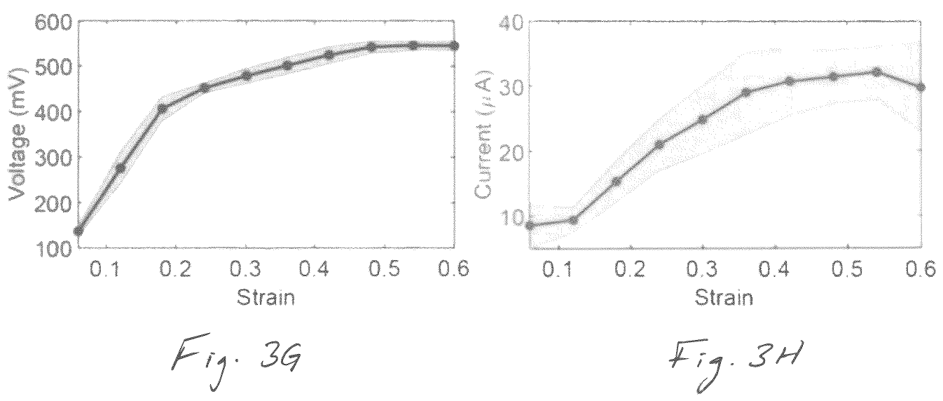

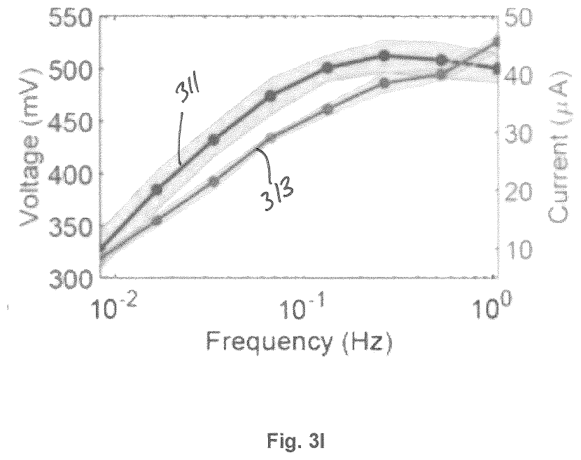

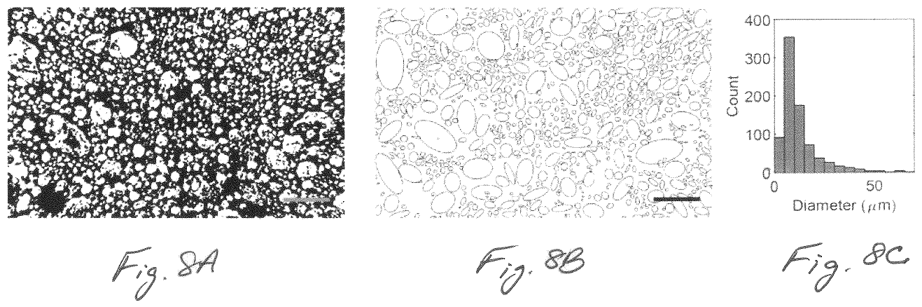

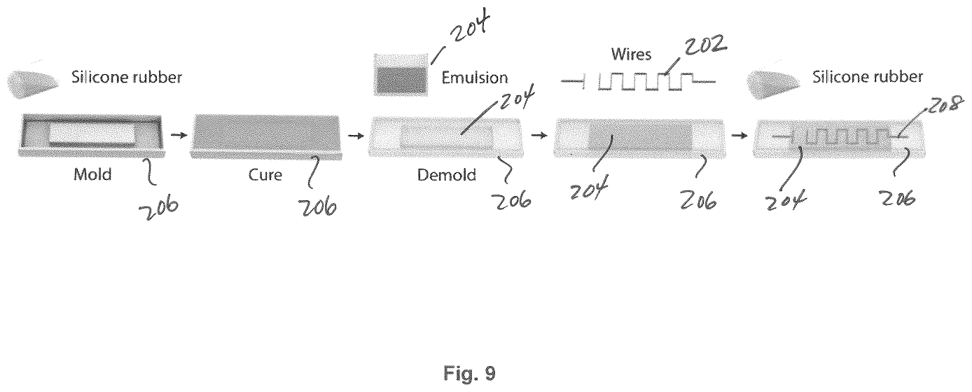

FIGS. 3A-3I include schematic diagrams illustrating a soft stretchable device 200, according to some exemplary embodiments. FIG. 9 includes a schematic diagram illustrating fabrication of stretchable devices 200, according to some exemplary embodiments. Referring to FIGS. 3A-3I and FIG. 9, the device includes liquid metal emulsion as described herein with 90 vol. % of liquid metal (FIG. 3A). The device 200 includes rigid wires 202 embedded in the emulsion 204 and is packaged by silicone rubber 206. Stretching the device 200 causes a relative movement of the anode 208 in the emulsion by a distance or length change ΔL. Strain is defined as ΔL/L₀. FIG. 3B includes a graph of open-circuit voltage of the device 200. FIG. 3C includes a graph of short-circuit current of the device 200. FIG. 3D is a graph illustrating peak voltage and current of the device under different external loads and strain of 0.3 at 1.3 Hz. Shaded areas represent standard deviations of 20 cycles. FIG. 3E includes a graph illustrating peak power of the device under different external loads and strain of 0.3 at 1.3 Hz. Shaded areas represent standard deviations of 20 cycles. FIG. 3F includes a graph illustrating peak voltages of four devices under strain of 0.3 at 0.1 Hz in different ambient conditions. The at-rest sample (curve 301) was fabricated one week before testing. The underwater sample (curve 303) was immersed in deionized water for two hours and dried in ambient environment before testing. The high-temperature sample (curve 305) was heated to 120° C. for two hours and then tested after it was cooled to room temperature. The control group (curve 307) was tested the same day of manufacture in ambient environment (21.2° C., 51.1% relative humidity). FIG. 3G includes a graph illustrating peak voltage at various stretching frequencies under strain of 0.3. Shaded areas represent standard deviations of five cycles. FIG. 3H includes a graph illustrating peak current at various stretching frequencies under strain of 0.3. Shaded areas represent standard deviations of five cycles. (FIG. 3I) includes a graph illustrating peak voltage (curve 311) and current (curve 313) under different strain inputs at 0.1 Hz. Shaded areas represent standard deviations of ten cycles. To form the device, silicone rubber was poured in a mold and cured. After demolding, liquid metal-emulsion and wires were added to the silicone rubber packaging. Additional silicone rubber was poured on the device 200 to fully enclose it.

Based on the principle of using wires to rupture the oxide skin of liquid metal droplets, according to the current technology, also provided are stretchable devices that can be activated by mechanical strain. In some exemplary embodiments, the soft silicone rubber (for example, Ecoflex 00-30) is used to fully enclose the liquid metal-ionic liquid emulsion 200. An emulsion with 90 vol. % of liquid metal was chosen because it induces higher voltage than emulsions with other concentrations (FIG. 2G). Emulsions with other concentrations can be used. The two wires were embedded in the emulsion as anode and cathode. The anode was formed in a serpentine shape to maximize its contact area with the emulsion and increase collisions with liquid metal droplets, thereby maximizing the peak potential difference. The flexible silicone rubber packaging and the viscoelastic emulsion allowed the device to be stretched reversibly. Because the wire material was stiffer than the emulsion, the anode underwent a translational movement inside the emulsion when the device was stretched and the wire ruptured the oxide skin of collided liquid metal droplets. Similar to the mechanism described above in detail, this process induced a potential difference between the anode and the cathode (FIG. 3A, FIG. 3B, and FIG. 3C). When the strain was released, the relative motion of the anode created another spike in open-circuit voltage or short-circuit current. Notably, the peak current was higher when the strain was removed compared to when the device was stretched because of the shorter distance between the two electrodes in the relaxed state (FIG. 3C).

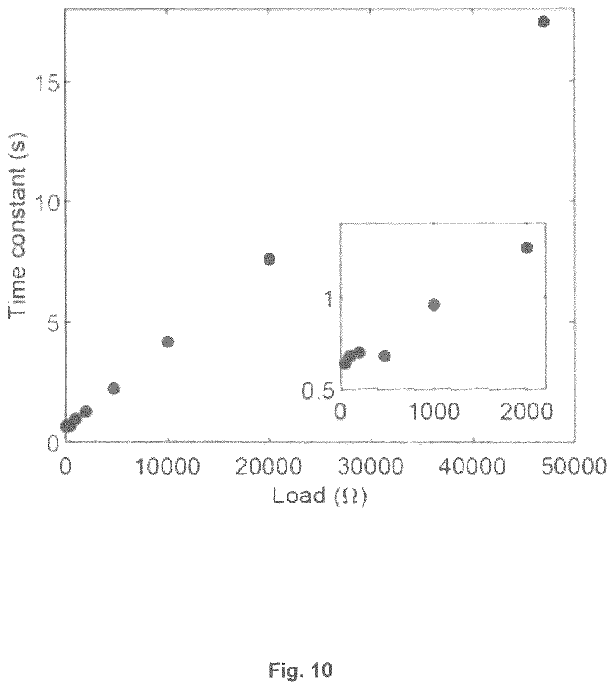

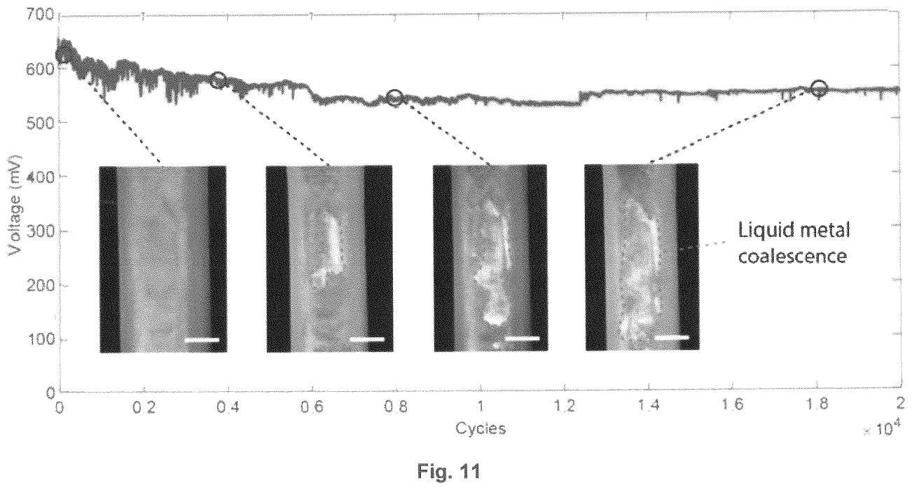

As is typical with batteries, the electrical output performance of this device depends on its external load. With higher load resistance, the peak open-circuit voltage increases, while the peak short-circuit current decreases (FIG. 3D). The maximum peak power is ˜4 μW under an optimal load of 4.7 kΩ (FIG. 3E). The decay time constant of the open-circuit voltage curve is proportional to load resistance (FIG. 10), which is a common characteristic observed in charged capacitors. FIG. 10 includes a graph illustrating time constants of the voltage decay curves of the stretchable battery of FIGS. 3A through 3I under different loads. The inset shows the details in the low-load region.

In addition, stretching the device at higher frequencies and under higher strains can improve its output performance, likely because the increased collisions between the anode and liquid metal droplets created more oxide ruptures (FIGS. 3G-I). We also investigated the cycling, at-rest, thermal, and aquatic stability of these batteries. A de-vice was stretched and released continuously for 20,000 cycles at 0.5 Hz to test its fatigue behavior (FIG. 11). FIG. 11 includes a graph illustrating a peak voltage profile of a stretchable battery of FIGS. 3A through 3I during 20,000 stretching cycles. The liquid metal droplets gradually coalesced as the stretching continued. Scale bars represent 5 mm.

It was observed that the liquid metal droplets started to coalesce as the collision between the electrode and droplets continued. The peak voltage slightly decreased from ˜650 mV as the liquid metal droplets coalesced and maintained ˜500 mV when coalescence appeared to stop. Because the oxide skin shielded the liquid metal inner core from external environment, the devices also performed well even after being subject to ambient conditions that are typically harsh for batteries, such as high temperature or aquatic environments (FIG. 3F). The sample in high temperature exhibited slightly lower voltage than other samples, possibly because the evaporation-induced reduction water in the sample limited its electrochemical reaction. Due to the protection provided by the passivating oxide skin and zero vapor pressure of the ionic liquid, the device remained shelf-stable after being manufactured without self-discharge, as demonstrated by a sample resting in ambient environment for seven days (FIG. 3F). These results demonstrated good stability of these stretchable batteries.

### Applications of Liquid Metal Emulsion-Based Devices

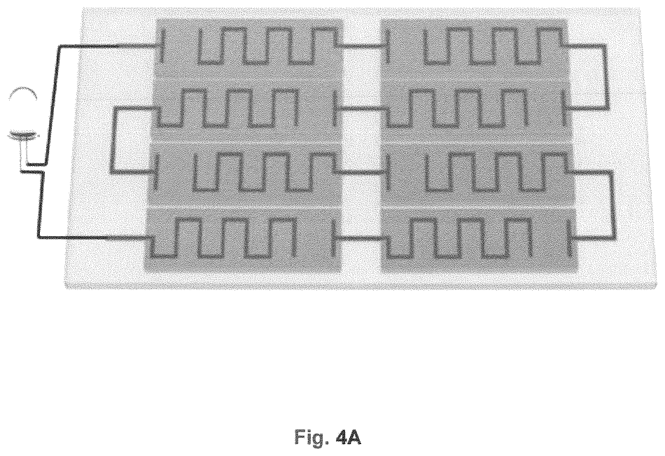

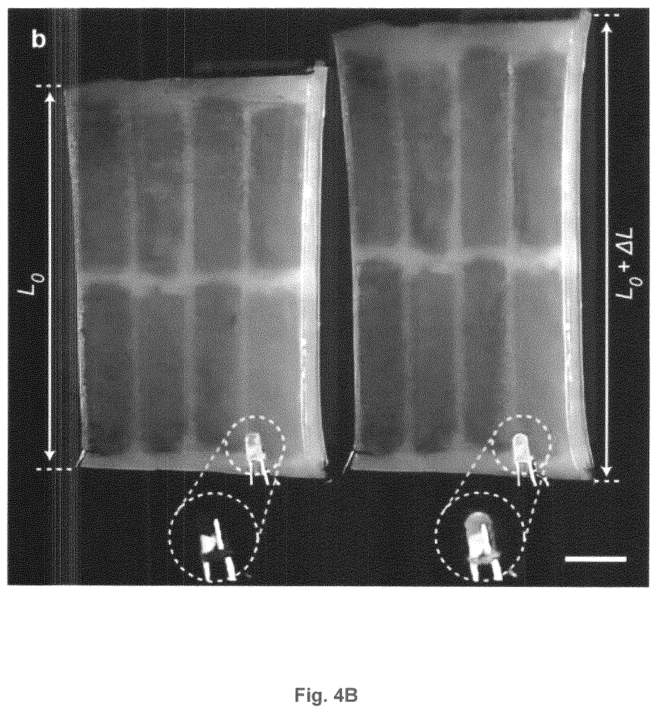

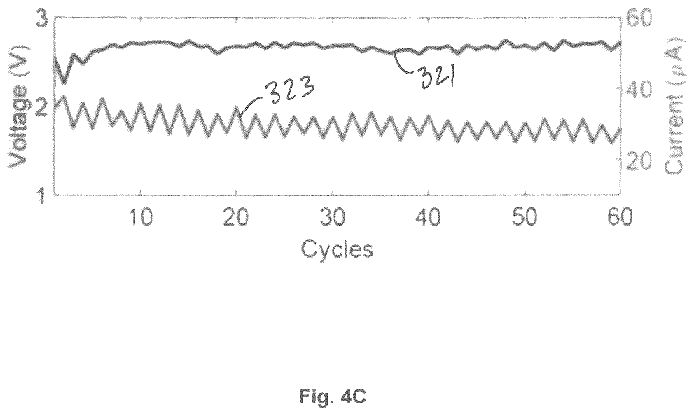

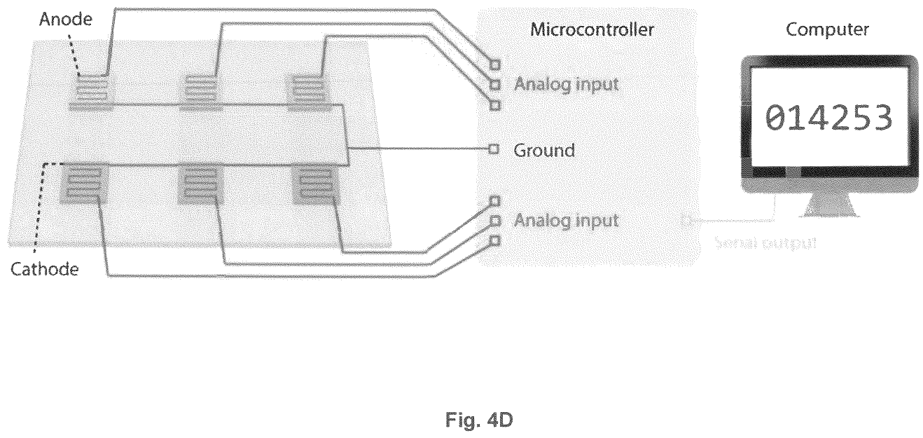

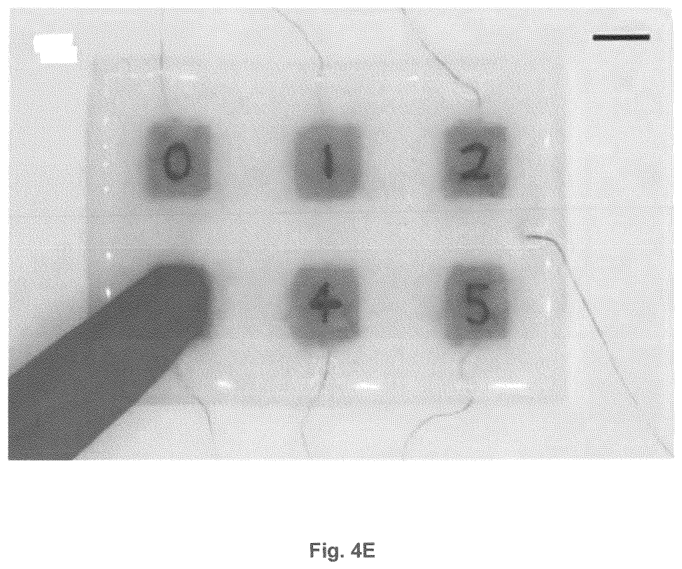

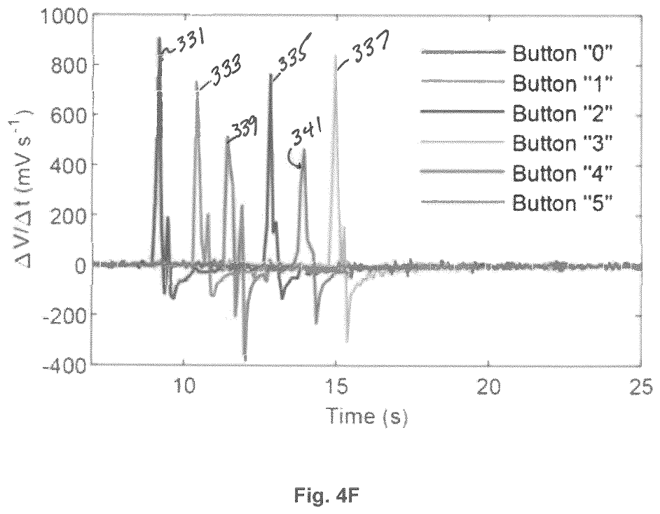

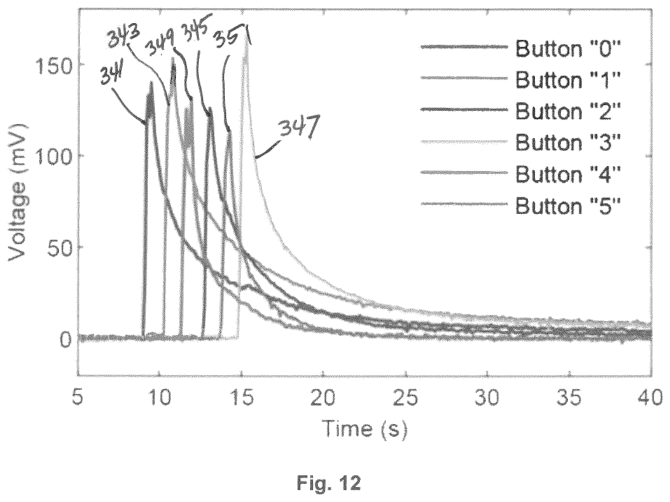

FIGS. 4A through 4F include schematic diagrams illustrating applications of the liquid metal emulsion-based device, according to some exemplary embodiments. FIG. 4A illustrates a liquid metal battery comprised of multiple interconnected devices. FIG. 4B illustrates the stretchable battery of FIG. 4A powering a light-emitting diode (LED). The circular inset images show the same LED in a darker environment. Scale bar represents 10 mm. FIG. 4C is a graph illustrating peak voltage (curve 321) and current (curve 321) of the device under strain of 0.3 at 0.5 Hz. FIG. 4D illustrates a soft keypad that responds to compression without external power. A microcontroller processes the voltage signal and sends it to the computer for display. FIG. 4E illustrates that the compression-responsive keypad of FIG. 4D reacts to mechanical inputs by a finger. Scale bar represents 10 mm. FIG. 4F is a graph illustrating derivative of voltage with respect to time of the six buttons of the keypad when they are pressed. Curves 331, 333, 335, 337, 339, and 341 represent the voltage time derivative for buttons 0 through 5, respectively. FIG. 12 includes a graph illustrating voltage change of the six buttons of the self-powered keypad when they are pressed. Curves 341, 343, 345, 347, 349, and 351 represent the voltage change for buttons 0 through 5, respectively.

Despite the peak voltage output of the liquid metal battery is limited to ˜500 mV, it is possible to increase the voltage by connecting multiple devices in series. As an example, we combined eight devices to boost the output voltage (FIG. 4A). Here, the emulsion in each device was constrained in their individual chamber and separated by silicone rubber, but the anode of one chamber was electrically connected to the cathode in the next chamber. The induced energy of this composite device was sufficient to power an LED (light emitting diode) when the soft battery was stretched (FIG. 4B and FIG. 4C).

We can also use this type of liquid metal emulsion-based device as a sensor without external power because it intrinsically responds to mechanical changes. We fabricated a soft self-powered keypad that produced voltage changes when the buttons were compressed (FIG. 4D and FIG. 4E). The embedded rigid anodes deflected and ruptured the liquid metal oxide in the emulsion, causing a sudden change in voltage output. A microcontroller registered these transient voltage changes and sent signals to a computer, which displayed the corresponding characters (FIG. 4F, and FIG. 12). The simplicity of this self-powered sensor design allows scalability and easy integration with other electronic components.

Described herein in detail is a method to induce electrochemical energy conversion from liquid metal by rupturing its outer oxide skin. The chemical energy of the spontaneous re-formation of the liquid metal oxide layer converts to electrical energy and it can be used as a new type of soft battery. Based on this technique, we demonstrated a stretchable battery design featuring an emulsion composed of liquid metal and ionic liquid. This simple structure was capable of producing up to ˜500 mV and 3.5 μW of power when stretched. Protected by the liquid metal oxide skin, the device has great stability and performs well in a variety of harsh environments. It can power other electronic components and can also serve as a self-powered mechanically-activated sensor. The device design is general, scalable, customizable, and easy to implement. These features make it a desirable candidate for soft and stretchable energy devices.

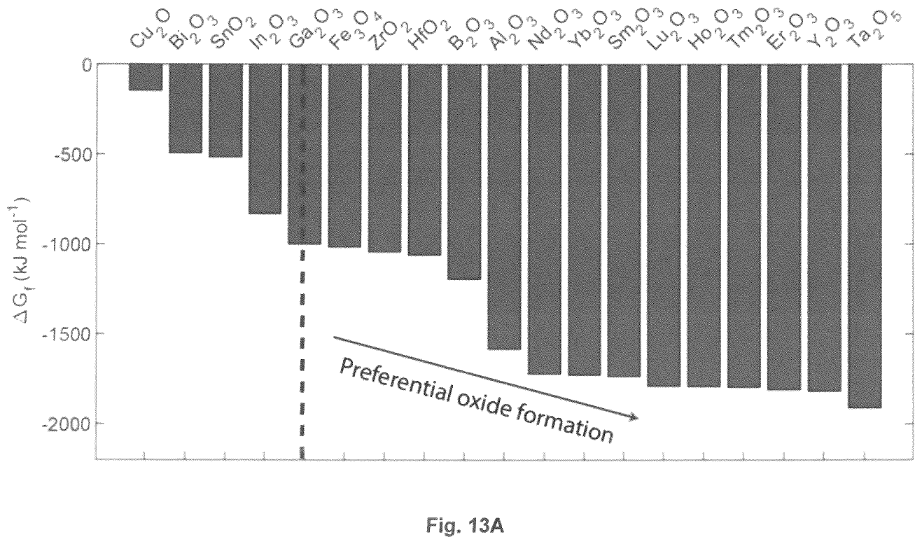

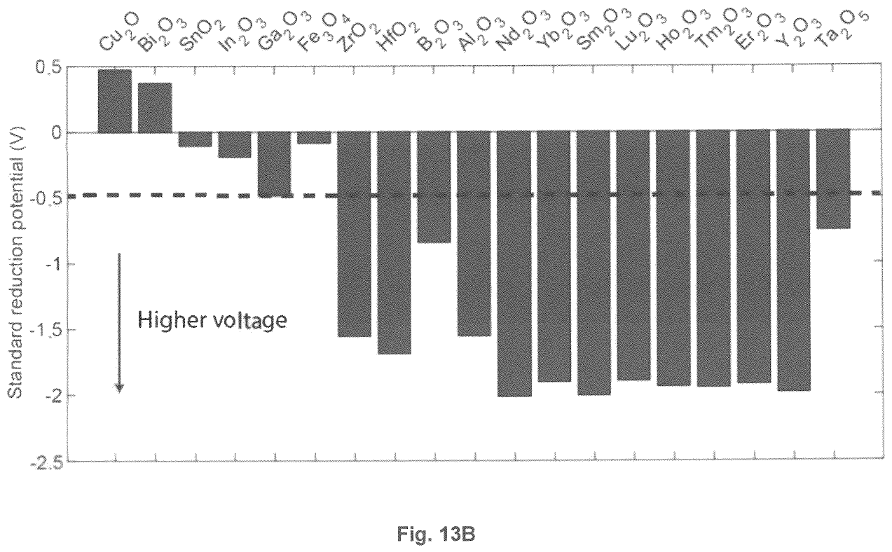

It is possible to further improve the energy output of this type of system. For example, there are other metal elements that develop oxide layers more easily than gallium according to the Gibbs free energy of formation of their corresponding oxides, as illustrated in FIGS. 13A and 13B, which illustrate Gibbs free energy and standard reduction potential of formations of select non-hazardous metal oxides. The open-circuit voltage of the electrochemical cell can be increased by doping gallium-indium liquid metal with metal elements that have lower standard reduction potentials and form oxide preferentially over gallium. One of the potential candidates is aluminum. Aluminum-doped liquid metal can produce 1.951 V of maximum voltage in theory, which is promising as a stretchable battery or self-powered sensor for many future applications. Some rare-earth elements can also produce higher voltage, but their applications may be limited due to supply shortage and high cost.

It is noted that the output current was not optimized in this study and it could be improved by adjusting the conductivity of the liquid metal emulsion. For example, metal-containing ionic liquids are highly conductive electrolytes with increased current densities. Polymeric ionic liquid electrolytes also exhibited high ion-conductive properties in battery systems. In addition, because copper wires are susceptible to corrosion when exposed to liquids, other materials for the wires could be more suitable to avoid any potential long-term corrosion. Future investigations may also involve implementing strategies, such as ionic liquid-based electrolysis, to make this device rechargeable. Altogether, this technology may inspire new battery designs featuring liquid metal surface oxide and open up new opportunities to harness their inherent energy for self-powered soft devices.

### Demonstration Implementation

In an exemplary demonstration implementation of the technology of the current disclosure, the materials used were as follows: Liquid metal (Metspec 60, 5N Plus), ionic liquid (1-ethyl-3-methylimidazolium di-cyanamide, Basionics VS 03, ≥98%, BASF SE), sodium chloride (99+%, Acros Organics), sodium hydroxide (≥98%, Sigma-Aldrich), fumed silica (Aerosil R 104, Evonik), and Ecoflex (00-30, Smooth-On).

For this exemplary demonstration implementation, for scratching the liquid metal surface: A plastic needle 15 (SmoothFlow Tapered Precision Dispense Tip, Gauge 27, Nordson) was secured on a linear stage (ATS150, Aerotech) of a custom gantry system (Aerotech). The controller of the gantry system (A3200, Aerotech) was programmed to move the needle 15 at a velocity of 40 mm/s. Liquid metals were injected into a 3D-printed container 18 (Form 3+, Formlabs) with two chambers 16A, 16B. Ionic liquid was poured into the container and 18 fully covered the surfaces of liquid metals. A digital multimeter (34465A, Keysight) was used to record the voltage or current between the liquid metals in the two chambers through tinned copper wires. The wires were electrically insulated from the liquid electrolyte and were in contact with liquid metals only.

Estimation of reaction lifetime of forming gallium oxide: The melting point of EGaIn changes depending on its composition. It transitions from 15.7° C. (below room temperature, 24 wt. % of indium) to 22.2° C. (room temperature, 28.7 wt. % of indium). Because the weight of EGaIn in a chamber 16A, 16B of the container 18 was 3.69 g, the liquid metal will not solidify until 0.71 g, or 0.0102 mol, of gallium is consumed. This process will transfer 0.0306 mol of electrons, which is equivalent to a charge of 2952.9 C. Based on the maximum output current (11.5 μA, FIG. 1F), the process of formation of gallium oxide can last at least 2.6×10⁸ s (8 years). At 1 A, a typical discharge current of alkaline batteries [64], the reaction can last 2.9×10³ s (49 min).

Preparation of liquid metal-ionic liquid emulsions: Liquid metal and ionic liquid were weighed into a 20 mL capacity plastic cup and mixed in a SpeedMixer (DAC 150.1 FVZ-K, FlackTek) at 3500 rpm. Fumed silica was added to this mixture and mixed at 3500 rpm (FIG. 7). See Table 1 for details about the weights of each component and mixing time.

Optical image of liquid metal-ionic liquid emulsion: The microscopic image of the liquid metal-ionic liquid emulsion (with reference to FIGS. 8A through 8C) was captured by a camera (U3-30C0CP Rev.2.2, IDS Imaging) with a miniature microscope system (Infini Tube FM-200, Infinity; Achrovid 10× objective, Infinity). The particle size distribution was determined by importing a microscopic image into an image analysing software (ImageJ2), segmenting the image to binary format (Huang thresholding method, Black and white color), and then calculating the diameters of the particles based on elliptical approximation (circularity 0.00-1.00).

Pulling wire inside emulsion: The liquid metal-ionic liquid emulsion was transferred to a 3D-printed container (Form 3+). Two tinned copper solid-core wires, stripped of their insulating layers, were inserted in the emulsion through holes in the container. One of the wires was secured on a linear stage (ATS150) of the gantry system. The controller of the gantry system (A3200) was programmed to pull and push the wire at a velocity of 40 mm/s while the digital multimeter (34465A) was recording voltage or current.

Fabrication of stretchable devices: The main part of the silicone rubber packaging was made by pouring a mixture of equal weight of Ecoflex 00-30 Parts A and B into a 3D-printed mold (Form 3+) and then demolded after curing in room temperature for four hours. The liquid metal-ionic liquid emulsion was then transferred to the center chamber of the silicone rubber packaging. Two tinned copper wires were placed inside the emulsion. Finally, additional mixture of equal weight of Ecoflex 00-30 Parts A and B was poured on the top of the device and allowed curing in room temperature for another four hours (with reference to FIG. 9).

Characterization of stretchable devices: The device was secured on the linear stage (ATS150) of the custom gantry system through a pair of metal clamps as electrodes and a custom fixture. The controller of the gantry system (A3200) was programmed to stretch and release one end of the device while the digital multimeter (34465A) was recording voltage or current. For tests with different external loads, various resistors were connected in parallel with the device in open-circuit condition or in series with the device in short-circuit condition. The power was calculated by multiplying the respective voltage and current.

Characterization of the keypad: The six buttons of the device shared the same cathode and it was connected to the ground pin of a microcontroller (UNO R3, Arduino). The anodes were individually connected to analog input pins through bias resistors. The microcontroller sent voltage data of six analog input channels to a Python program on a computer via serial communication. The computer program detected the voltage changes of the six channels and displayed button inputs on a graphical user interface.

TABLE 1
Preparation of liquid metal-ionic liquid emulsions.

| Liquid metal | EGaIn | Ionic | Mixing | Fumed | Mixing |
|---|---|---|---|---|---|
| vol. % | (g) | liquid (g) | time (min) | silica (g) | time (min) |
| 90 | 16.875 | 0.318 | 3 | 0.030 | 5 |
| 70 | 13.125 | 0.954 | 3 | 0.200 | 8 |
| 50 | 9.375 | 1.590 | 3 | 0.400 | 10 |
| 30 | 5.625 | 2.226 | 3 | 0.600 | 10 |
| 10 | 1.875 | 2.862 | 3 | 0.800 | 10 |

What is claimed herein is:

1. A method of generating electrical energy, comprising:
providing a composite material comprising a plurality of liquid metal droplets dispersed in at least one of an ionically-conductive liquid or an ionically conductive polymer;
enclosing the composite material within a flexible, stretchable enclosure;
embedding at least two electrodes within the composite material; and
mechanically deforming the enclosure to cause relative movement between at least one of the electrodes and the composite material, thereby rupturing oxide layers present on surfaces of the liquid metal droplets and inducing an electrochemical reaction that generates electrical energy.

2. The method of claim 1, wherein the liquid metal droplets comprise a gallium-based alloy.

3. The method of claim 1, wherein the ionically-conductive liquid comprises an ionic liquid selected from 1-ethyl-3-methyl-imidazolium dicyanamide, 1-ethyl-3-methyl-imidazolium acetate, or 1-ethyl-3-methyl-imidazolium ethyl sulfate.

4. The method of claim 1, wherein the fumed silica particles are present in an amount of 0.1 wt % to 10 wt % based on a total weight of the composite material.

5. The method of claim 1, wherein the flexible, stretchable enclosure comprises a silicone elastomer and the mechanical deformation comprises applying a tensile strain of at least 5%.

6. The method of claim 1, further comprising repeatedly deforming the enclosure at a frequency between 0.1 Hz and 5 Hz to generate successive electrical pulses.

7. The method of claim 1, wherein the composite material is configured such that energy generation is mechanically gated and substantially absent when the device is at rest.

8. The method of claim 1, wherein the voltage and/or power output is increased by electrically connecting multiple devices in series or parallel.

9. The method of claim 1, wherein the liquid metal is doped with a metal selected from aluminum, rare-earth metals, or combinations thereof, to increase the open-circuit voltage of the device.

10. The method of claim 1, wherein the electrodes are made from a material selected from copper, carbon, stainless steel, or combinations thereof.

11. A stretchable battery device, comprising:
a composite emulsion comprising a plurality of liquid metal droplets dispersed in at least one of an ionically-conductive liquid or an ionically conductive polymer;
a flexible, stretchable enclosure encapsulating the composite emulsion; and
at least two electrodes embedded within the composite emulsion, wherein at least one electrode is configured to move relative to the composite emulsion upon mechanical deformation of the enclosure such that the movement ruptures oxide layers on the liquid metal droplets and generates electrical energy.

12. The stretchable battery device of claim 11, wherein the enclosure comprises silicone rubber and the at least two electrodes comprise tinned copper wires, an anode wire being formed in a serpentine pattern to increase collisions with the liquid metal droplets.

13. The stretchable battery device of claim 11, wherein the composite emulsion comprises a plurality of liquid metal droplets, an ionically-conductive liquid, and fumed silica particles present in an amount sufficient to stabilize the dispersion of the liquid metal droplets within the ionically-conductive liquid.

14. The stretchable battery device of claim 11, wherein the device is robust against self-discharge and environmental degradation due to the presence of the oxide layer and the stability of the ionic liquid.

15. The stretchable battery device of claim 11, wherein the device is configured for use in wearable electronics, soft robotics, or implantable medical devices.

16. The stretchable battery device of claim 11, wherein the composite emulsion further comprises fumed silica particles.

17. A self-powered sensor device, comprising:
a composite emulsion comprising liquid metal droplets dispersed in an ionically-conductive liquid or an ionically-conductive polymer;
a flexible enclosure containing the composite emulsion; and
at least one rigid electrode embedded within the composite emulsion and configured such that mechanical input to the enclosure causes the electrode to rupture oxide layers on the liquid metal droplets, thereby generating a transient electrical signal in response to the mechanical input.

18. The self-powered sensor device of claim 17, wherein the rigid electrode comprises copper or stainless steel and is oriented so that compression perpendicular to the enclosure deflects the electrode through the composite emulsion.

19. The self-powered sensor device of claim 17, further comprising a signal-processing circuit configured to detect voltage transients generated by the device and to output corresponding digital signals.

20. The self-powered sensor device of claim 17, wherein the composite emulsion further comprises fumed silica particles.

21. A composite material for electrochemical energy generation, comprising:
a plurality of liquid metal;
an ionically-conductive liquid or ionically conductive polymer in which the liquid metal or polymer droplets are dispersed; and
fumed silica particles present in an amount sufficient to stabilize the dispersion of the liquid metal droplets within the ionically-conductive liquid, wherein the composite material is configured to generate electrical energy upon mechanical rupture of oxide layers on the liquid metal droplets.

22. A method of fabricating a stretchable battery, comprising:
preparing a composite emulsion by mixing liquid metal, an ionically-conductive liquid, and fumed silica particles to form a stabilized dispersion of liquid metal droplets;
enclosing the composite emulsion within a flexible, stretchable polymeric enclosure; and
embedding at least two electrodes within the composite emulsion, wherein the electrodes are positioned such that mechanical deformation of the enclosure causes at least one electrode to rupture oxide layers on the liquid metal droplets, thereby enabling electrochemical energy generation.
